(19) United States
(12) Patent Application Publication
(10) Pub. No.: US 2026/0107051 A1
(43) Pub. Date: Apr. 16, 2026

(54) ILLUMINATION AND VISUALIZATION METHOD AND SYSTEM

(71) Applicant: Robert S. HABER, Pepper Pike, OH (US)

(72) Inventor: Robert S. HABER, Pepper Pike, OH (US)

(21) Appl. No.: 19/355,498

(22) Filed: Oct. 10, 2025

Related U.S. Application Data
(60) Provisional application No. 63/706,061, filed on Oct. 11, 2024.

(51) Int. Cl. H04N 23/57; G02C 7/08; H04N 13/239; H04N 23/54; H04N 23/56; H04N 23/61; H04N 23/74

(52) U.S. Cl. CPC H04N 23/57; G02C 7/088; H04N 13/239; H04N 23/54; H04N 23/56; H04N 23/61; H04N 23/74

(57) ABSTRACT

Provided is an improved lighting and visualization system for monocular systems, binocular systems, or loupes. The lighting and visualization system includes a chassis for holding an LED printed circuit board with a plurality of LEDs, a mounting ring, and a plurality of lenses installed within the mounting ring. The improved lighting and visualization system further includes at least one video camera system. At least one component of the lighting and visualization system attaches to a monocular system, binocular system, or pair of loupes to provide lighting of a user's specific field of view and visualization of the same.

### RELATED APPLICATIONS

This application claims the benefit of U.S. Provisional Application No. 63/706,061 filed Oct. 11, 2024, which is hereby incorporated herein by reference.

### FIELD OF INVENTION

The present invention relates generally to visual aid devices such as monocular systems, binocular systems, or loupes.

### BACKGROUND

Visual aid devices may be used for tasks requiring an enhanced field of view, increased magnification, or increased focus. Such visual aid devices may include monocular and binocular systems such as through-the-lens loupes or in-front-of-the-lens loupes. Visual aid devices such as these may be particularly useful for medical professionals, scientists, professors, students, jewelers, gemologists, hobbyists, or the like.

### SUMMARY OF INVENTION

The present application provides embodiments of an improved visual aid device that delivers enhanced performance, lighting, and/or integrated video systems. The improved visual aid device may be secured to existing visual aid devices such as loupe glasses to increase functionality and performance. Alternatively, the methods and devices described herein may be utilized when constructing as an all-in-one loupe device having enhanced performance, lighting, and/or integrated video.

According to an embodiment, a lighting and visualization system may comprise a chassis comprising a first portion, a second portion, and a camera mounting channel extending along the first portion, an LED board comprising a plurality of LEDs, a mounting ring comprising a plurality of openings, a plurality of lenses, each of the plurality of lenses installed within a respective opening of the mounting ring to align a respective lens with a respective LED of the LED board, where the LED board and the mounting ring are installed within a cavity of the second portion of the chassis, and at least one camera installed on the chassis proximate the camera mounting channel, where the first portion of the chassis is configured to attach to an ocular of a visual aid device to provide improved lighting and visualization for the visual aid device.

The system and methods of the current application may increase user efficiency and workflow in clinical settings and other industries by integrating a controllable illumination arrangement to loupe lenses. The illumination may be applied directly at the point of view and the field of view, emanating from the periphery of the lenses. Moreover, the system and method may also incorporate a stereo video feed for loupe lenses that may replicate a user's visual point of view. This may facilitate real-time sharing of the user's perspective, which can improve peripheral activities such as audits, educational workflows, workflow documentation, and other display applications.

The foregoing and other features of the application are described below with reference to the drawings.

### BRIEF DESCRIPTION OF THE DRAWINGS

FIG. 1 is an illustration of a pair of through the lens loupes.

FIG. 2 is an exemplary illustration of an improved lighting and visualization device according to the disclosure provided herein.

FIG. 3 is a second exemplary illustration of the improved lighting and visualization device according to the disclosure provided herein.

FIG. 4 is a rear perspective view of a chassis of the improved lighting and visualization device according to the disclosure provided herein.

FIG. 5 is a front perspective view of the chassis of the improved lighting and visualization device according to the disclosure provided herein.

FIG. 6 is a top plan view of the chassis of the improved lighting and visualization device according to the disclosure provided herein.

FIG. 7 is a cross-sectional view of the chassis of the improved lighting and visualization device, taken about line 7-7 of FIG. 6.

FIG. 8 is a front view of the chassis of the improved lighting and visualization device according to the disclosure provided herein.

FIG. 9 is a system diagram of an improved lighting and visualization system according to the disclosure provided herein.

FIG. 10 is an exemplary illustration of the improved lighting and visualization system, in use, according to the disclosure provided herein.

FIG. 11 is another exemplary illustration of the improved lighting and visualization system, in use, according to the disclosure provided herein.

FIG. 12 is an exemplary illustration of the improved lighting and visualization device attached to a pair of existing loupes.

### DETAILED DESCRIPTION

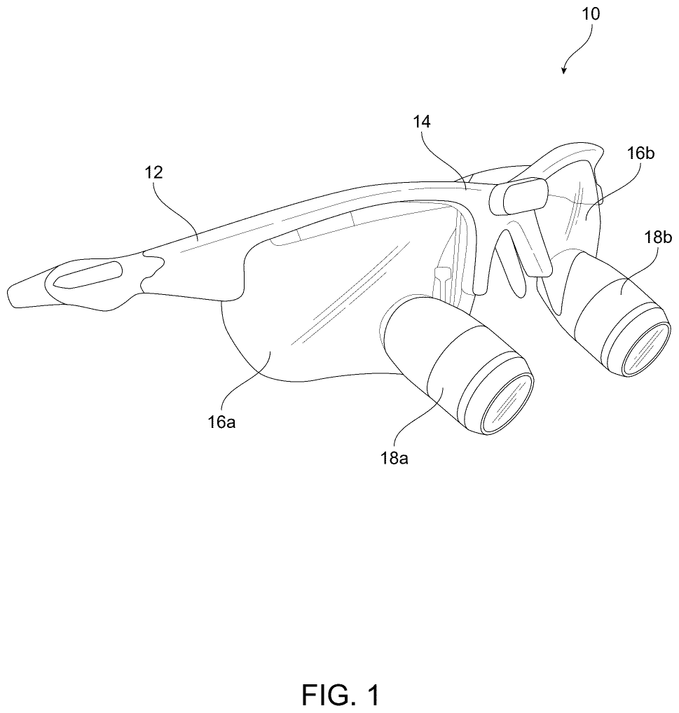

FIG. 1 illustrates an exemplary embodiment of a conventional pair of loupe glasses 10. Particularly, the loupes 10 feature a frame 12, a neck 14, a pair of lenses 16a and 16b, and a pair of oculars 18a and 18b. In this example, the pair of loupes 10 is referred to as through-the-lens loupes as the oculars 18a and 18b are attached to and pass through the front of respective lenses 16a and 16b. It should be appreciated, however, that other styles of loupes, such as in-front-of-the-lens loupes, are also commonly used and are equally as applicable to this disclosure.

It may be desirable to provide improved lighting or camera systems to existing loupes, such as the loupes 10. Existing lighting or camera solutions may exist on the market today and may attach to the loupes 10 at the neck 14, for example. These loupe lighting and camera solutions, however, may be frustrating, bulky, and cumbersome in establishing proper lighting of a surgical target or proper visualization of the target for video capture. They may also be difficult to attach, focus, and direct to a desired viewing target. Moreover, the lighting and camera placement may be such that it is mis-aligned with a user's eyes or the oculars 18 of a pair of loupes 10. Those that have used conventional lighting and camera solutions are very familiar with the shortcomings and difficulties associated with the same.

Moreover, existing loupes or camera systems can restrict the field of vision due to limited space and lighting, which may impact a clinician's, or any other industry user's ability to perform precise movements. The current application describes systems and methods that may improve or eliminate the frustrations and difficulties associated with conventional retrofit lighting or video devices on the market today. For instance, embodiments described herein may feature systems that ensure illumination is generated at the point of view (PoV) so that the illumination is directly applied at the field of view (FoV). The current application also addresses the disadvantages related to limited FoV by adding stereo video capabilities that can be adjusted to enhance, modify or otherwise improve the FoV in real-time with the aid of displays. As described herein, PoV may refer to a location or point near or proximate the loupe glasses and/or lenses (e.g., at a user's point of view). FoV may refer to a range of a user's observable view that can be seen at a given time through the loupes or camera devices. The FoV can be measured horizontally, vertically, or diagonally.

Another limitation of current loupe devices is that wearing loupes may alter a clinician's sensorimotor coordination, as the eyes shift from magnified to non-magnified fields, potentially affecting balance and neck position. Sensorimotor coordination is the combination of sensory inputs and motor outputs for humans that enable controlled and adaptive movement. It relies on the brain's ability to process information from vision, touch, balance, and body position to guide precise muscle actions. Impaired sensorimotor coordination can affect basic and complex tasks, from walking to handling instruments. For medical professionals, especially surgeons and clinicians, such impairments can compromise precision, increase the risk of error, and reduce overall performance, making accurate assessment and enhancement of sensorimotor function critically important in healthcare settings. The methods discussed herein may address these sensorimotor alterations by providing an alternative view of the clinician, or otherwise user into a display using the stereo vision system as input.

Furthermore, although some loupes come with attached lighting options, the illumination provided can be less effective than lighting systems integrated into other devices such as microscopes. The system and methods described herein may enable a user to autonomously or manually control the illumination of the FoV for improved comfort and performance. This may be accomplished, in part, by placing a lighting system and/or a video system directly at the PoV such that the lighting system and/or camera system is directly aligned, with the user's FoV.

In other words, an improved solution that facilitates ideal lighting and video capture may save time, effort, and in the example of surgical procedures, may improve surgical efficiency.

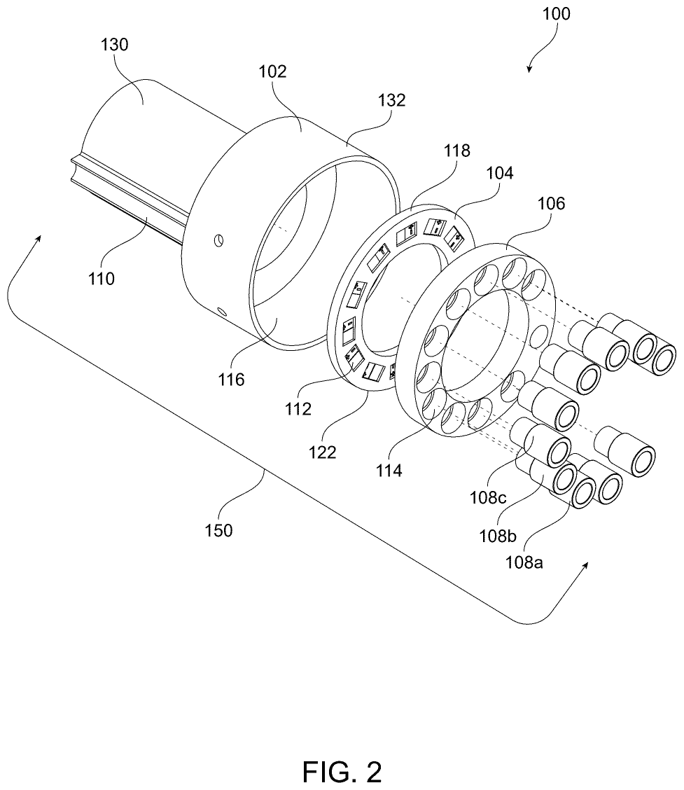

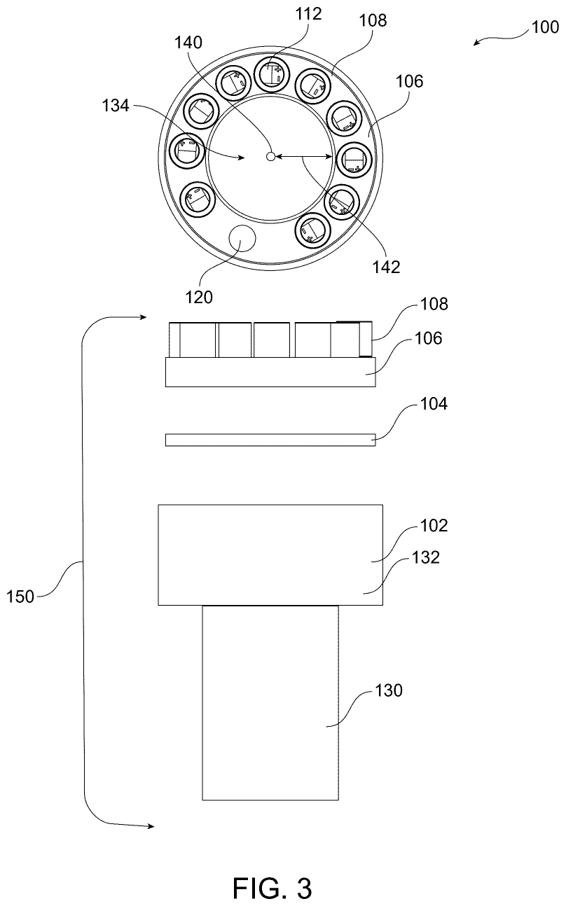

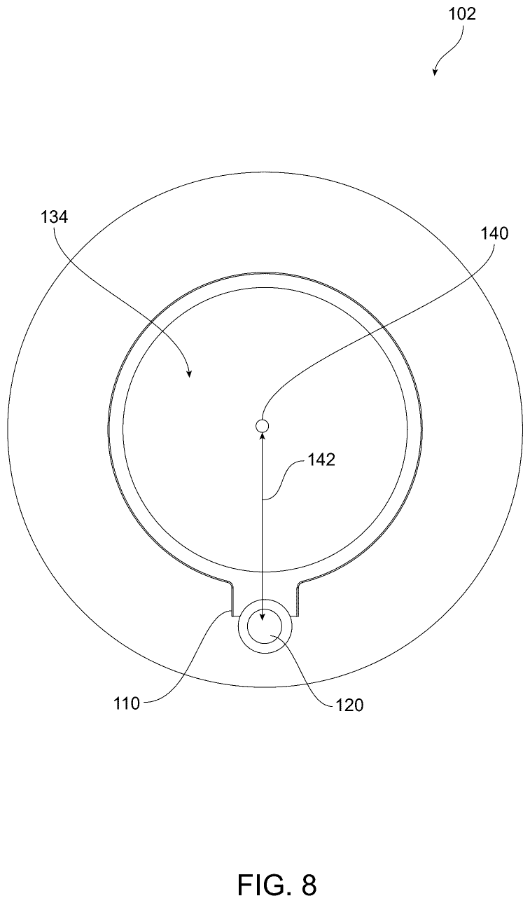

Turning to FIGS. 2 and 3, a system 100 is disclosed. The system 100 may comprise an improved illumination and visualization device 150 which may comprise a chassis 102, a board 104, a mounting ring 106, and a plurality of lenses 108. The chassis 102 may support, within the chamber 116, each of the board 104, the mounting ring 106, and the plurality of lenses 108. Moreover, the chassis 102 may further comprise at least one camera mounting channel 110 for supporting at least one camera or video capture device 120 (see FIG. 8). The system 100 and/or the device 150 may further comprise at least one battery or power supply, and at least one controller or processor with a memory and computer executable instructions. It should be appreciated that the various components of the system 100 and/or the device 150 may be located at or affixed to the device 150 or they may be located at an external location and connected through wired or wireless communication. For instance, the video capture device 120 may be fixed to the device 150 while the battery or power supply, and controller or processor with a memory and computer executable instructions may be located away from the device 150. However, it should be understood that any or all, or a combination of components may be located at or proximate to the device 150 or at an external location. To facilitate control or transfer of data and commands, the device 150 may include various communication modules or devices.

As discussed below, the illumination and visualization device 150 may be attached to the oculars 18 of an existing pair of loupes 10 or may be manufactured as part of the lenses or ocular devices themselves.

The board 104 may comprise a plurality of light-emitting-diodes (LEDs) 112, at least one PCB 118, and at least one heat-sink 122. The plurality of LEDs 112 may be provided on a single PCB 118, or plural PCBs 118, which may provide electrical connections to each of the LEDs 112. Each of the LEDs 112 may comprise similar lighting characteristics, or alternatively, each of the LEDs may comprise different lighting characteristics. That is, LEDs of various colors, wavelengths, sizes, intensities, or warmth may be provided. By way of example, a PCB 118 may be provided with ten LEDs. Five of the LEDs may be rated at 5000 Kelvin and five of the LEDS may be rated at 2700 Kelvin. In this manner, different illumination characteristics may be provided (e.g., cool white light, natural light, warm light, etc.). As discussed below, a controller may be configured to analyze sensed polarization parameters to produce an improved image quality by adjusting control parameters of the LEDs to achieve a more desirable image. By way of example, the control parameters that may be adjusted to include one or more of illumination intensity, wavelengths, color temperature, color profile, and other similar parameters that may be adjusted for LEDs.

It should be appreciated that any number or combination of LEDs may be provided, and each LED or group of LEDs may be controlled independently from one another to achieve desirable lighting characteristics or polarization. In the example illustrated in FIG. 2, the LEDs may be concentrically and evenly spaced around a circumference of the board 104/PCB 118. It should be understood, however, that other spacing and configurations may be possible.

The mounting ring 106 may comprise a plurality of concentrically and evenly spaced openings 114. Each of the openings 114 may accept a respective lens 108. In other words, each of the lenses 108 may fit into a respective opening 114 of the mounting ring 106. Each of the openings 114 and lenses 108 may be aligned with a respective LED 112 on the board 104 to achieve desired lighting characteristics.

By way of example, each lens 108 may be aligned and calibrated in terms of field of view, focal point, distance of illumination and other illumination and visualization characteristics. It should be appreciated that each lens may be calibrated independently according to a specified need or may be calibrated in a manner similar to one another. Once aligned and calibrated, the plurality of lenses 108 may mounted in the mounting ring 106, where they may be aligned and calibrated again as a sub-system. Then, the mounting ring 106, with lenses 108 may be coupled to the board 104 for creating the illumination sub-system. The illumination sub-system may comprise the illumination components such as the board 104, the mounting ring 106 the lenses 108, the LEDs 112, and any other device or component of the lighting system 100.

To achieve various lighting characteristics and profiles, any individual or combination of LEDs 112 may be operated at a given time. For instance, LEDs 112 aligned with specific lenses 108 may be operated to achieve a first lighting profile, and a second grouping of LEDs 112 aligned with a second grouping of lenses 108 may be operated to achieve a second lighting profile. And as discussed above, each individual LED 112 may be operated independently from one another to achieve an infinite number of specifically tailored lighting profiles as required or desired by an end user or as commanded automatically by a controller of the system 100.

A video capture device or camera 120 may be mounted on the chassis 102 within the camera mounting channel 110. The camera field of view may be aligned to or with the illumination pattern created by the illumination sub-system. In other words, the camera 120 may be aligned in a direction similar to the illumination pattern created by the plurality of LEDs of the lighting system. In this manner, the camera 120 and the LEDs 112 may be directed at the same point of interest.

In one embodiment, the system 100 has at least one camera, mounted to a single chassis 102. The camera 120 may be used for visualization of the field of view and may also be used as an input sensor for reading various illumination characteristics. The input signal from the input sensor may be used to correct illumination characteristics dynamically, such as light intensity, light wavelength, polarization and other illumination characteristics.

In another embodiment, the system 100 has two cameras 120, each mounted on a respective chassis 102, where each respective chassis 102 is mounted on a respective lens or ocular 18 of a loupe 10. In other words, the system 100 may comprise two improved lighting and visualization devices 150, one for each eye or ocular 18. A first lighting and visualization device 150a may be attached to a first ocular 18a and a second lighting and visualization device 150b may be attached to a second ocular 18b. Each of the cameras 120 may be used for visualization of the combined field of view and/or as combined input sensors of illumination characteristics. The combined input signal from the sensors/cameras 120 may be used to correct illumination characteristics dynamically, such as light intensity, light wavelength, polarization and other illumination characteristics.

In other embodiments, each lighting and visualization device 150 may comprise more than one camera 120. By way of example, different cameras may be used for different visual needs (e.g., high light, low light, differing fields of view, etc.). In either embodiment, the system 100 may use its sensor or plurality of sensors (e.g., cameras 120) to evaluate the field of view and its illumination characteristics. The system 100 may also use vision algorithms to align a field of view mask to the illuminated field of view. Similarly, the system may use vision algorithms to reduce glare, and other illumination aberrations for visualization enhancement.

It should be appreciated that the video feed may be either a mono or stereo video feed depending on the number of cameras 120 used to provide the video. In either case, the video may be presented digitally in any suitable manner. For instance, the video feed may be presented, in real-time to a video monitor, a cellular device, a tablet device, or may be streamed via the Internet or local area network. The video feed may be recorded for viewing at a later time. This may address the illumination, and video sharing shortcomings of existing monocular and binocular visual aid devices. These video sharing capabilities may also improve collaborative efforts through knowledge transfer using a real-time, PoV stereo vision sharing system. Those skilled in the art will appreciate the value in a system such as this. For example, video sharing capabilities may be useful for workflow audits, educational purposes, workflow documentation, and display applications.

The video capture device 120 referenced herein may include any suitable image capture technology capable of recording still images and/or live video. Examples of such devices include, but are not limited to, digital cameras (e.g., CCD or CMOS-based sensors), smartphone cameras, webcams, DSLR or mirrorless cameras, thermal imaging cameras, night vision cameras, depth cameras (e.g., time-of-flight or structured light sensors), 360-degree or panoramic cameras, and other commercially available or custom imaging systems. The camera may support various resolutions, frame rates, and compression formats depending on the application. It may be integrated into the device housing or externally connected via wired (e.g., USB, HDMI) or wireless (e.g., Wi-Fi, Bluetooth) interfaces. Additionally, the video capture 120 may include supporting components such as lenses, filters, image processors, and storage or transmission modules as needed for capturing and delivering the desired visual data.

In certain embodiments, the system 100 may include two cameras 120 arranged to capture images and/or video feeds from slightly different perspectives (e.g., similar to human vision with two eyes). This dual-camera configuration enables the generation of a stereo image or photo feed, which can be used to extract depth information, support 3D reconstruction, or enhance spatial awareness in image processing applications. The cameras may be positioned with a fixed baseline distance between them and may be synchronized to capture frames simultaneously. In the examples provided herein, the fixed baseline distance is the distance between ocular 18 of a pair of loupes 10, which can be configurable based on different sizes or pairs of loupes. The resulting image data from both cameras 120 may be processed using stereo matching algorithms to produce depth maps, disparity maps, or other forms of three-dimensional representations. The stereo camera pair may consist of identical or different types of cameras 120 (e.g., two RGB cameras, or one RGB and one infrared camera) depending on the requirements of the application. Additionally, calibration procedures may be implemented to align the image outputs and correct for lens distortion or parallax errors. The stereo imaging system may be integrated into a single housing or implemented using discrete, spatially separated camera modules. The processing and analysis of the image data and stereo image data matching and other various needs may be accomplished by a controller having a processor, as discussed below.

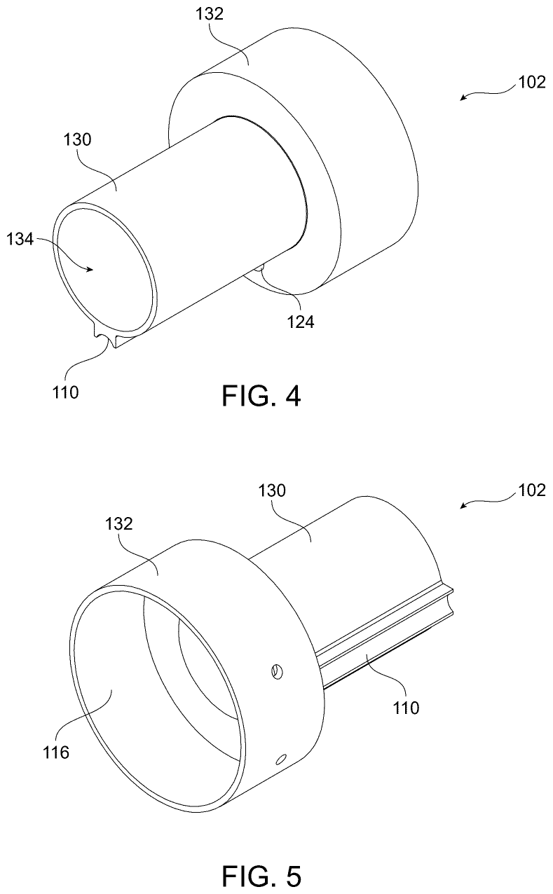

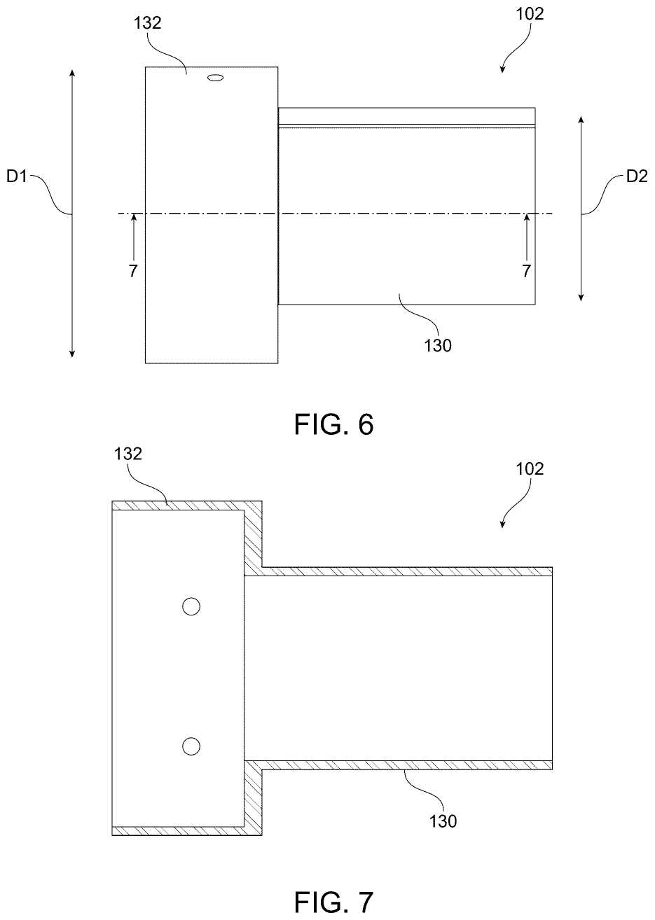

As discussed herein, the one or more lighting and visualization devices 150 may be attached to a pair of existing loupes 10. Specifically, as illustrated in FIGS. 4-8, an inner diameter of the first portion 130 of the chassis 102 may be sized according to an outer diameter of the oculars 18 of the loupes 10. In this way, the chassis 102 may be affixed to the oculars 18 of the loupes 10 by way of pressure fit. That is, the first potion 130 may correspond in shape and size to the oculars 18 and may fit over top of the oculars 18. In other embodiments, the chassis 102 may be affixed to the oculars 18 of the loupes 10 using any suitable attachment technique such as adhesive, screws, tape, or the like. The attachment may be permanent or temporary such that the one or more lighting and visualization devices 150 may be suitably attached or removed from the loupes 10 as necessary. The second portion 132 of the chassis may be sized and shaped according to the outer diameter of the board 104 and the mounting ring 106. In the embodiment illustrated herein, the diameter of the first portion 130 is smaller than the diameter of the second portion 132, however, it should be appreciated that the diameters of the first portion 130 and the second portion 132 can be equal in diameter or opposite of what is illustrated.

Moreover, the chassis 102, the board 104, and the mounting ring 106 each are circular in shape and comprise an opening 134 extending through the center of the device. The opening 134 may be configured to align with a field of view of an ocular 18 of the pair of loupes 10. That is, the opening 134 may allow the user of the loupes 10 to look through the oculars 18 without being obstructed by any of the components of the lighting and visualization device 150. In this manner, the user's view is not altered or obstructed by the addition of the devices or systems disclosed herein. In this example, the opening 134 extends through the chassis 102, the board 104, and the mounting ring 106 such that the center of the opening, or the center of each device is aligned with an axis extending through the center of the lighting and visualization device 150. In the examples provided, the oculars 18 and the chassis 102 are circular in shape; however, it should be appreciated that the various components of the device 150 can be adapted to fit any suitable pair of loupes 10 and/or oculars 18.

Said differently, the lighting and visualization device 150 includes the chassis 102 having the first portion 130 and the second portion 132, the board 104, and the mounting ring 106, each having a central opening. The components are arranged such that their central openings are concentrically aligned along a common central axis, forming a continuous visual pathway through the lighting and visualization device 150. The aligned openings are configured to permit unobstructed vision through the centers of the components, enabling a user to view or observe an area, target, or FoV beyond the lighting and visualization device 150 as if the device were not there. That is, the user's vision through the loupes 10 is unobstructed by the lighting and visualization device 150.

Because the camera 120 may be mounted within the channel 110 of the first portion 130, and because the second portion 132 is larger in diameter than the first portion 130, an opening 124 within the second portion 132 may be required. For example, see FIG. 4. The opening 124 can be made in the surface adjacent to the outer diameter of the second portion 132 to allow the camera 120 to visualize the workpiece and FoV through the second portion 132. As discussed, the second portion 132 faces toward the workpiece and FoV, while the first portion 130 faces towards the loupes 10 and corresponding user. It should be noted that the camera 120 may be placed in other locations on the chassis 102, such as on the outer diameter of the second portion 132. However, placement of the camera on the first portion 130 may allow for the camera PoV to be closer to the PoV of the user, which may create a more desirable camera or video capture feed.

As discussed above, the system 100 and the device 150 may orient and position the camera 120 as close to the field of view or the center axis of the ocular 18 as reasonably possible. To avoid modification to the oculars 18 of a pair of loupes 10, a camera 120 may be placed on the outside of the loupes. In conventional camera systems for loupes, the camera is placed near the bridge 14 of the loupes 10 to avoid obstructing the field of view of the user. However, because of this, the camera's field of view differs from that of the user because the camera is spaced a significant distance away from the center axis of the ocular 18. The device described herein positions the camera 120 proximate the center axis of the ocular 18 to achieve more desirable vision and image capture without obstructing the view of the user. The plurality of LEDs 112 may be placed the same distance away from the center axis 140 of the ocular 18 as the camera 120. As best illustrated in FIG. 3 or FIG. 8, the plurality of LEDs 112 are concentrically spaced around the center point 140 of the chassis 102 (and the ocular 18) at a predefined radius 142. The camera 120 may be positioned with a similar predefined radius 142 from the center point of the chassis 102 (and the ocular 18). Where the plurality of LEDs 112 and the camara 120 are spaced a same radius 142 from the center 140, a break in the concentrically spaced LEDs may be used to make space for the camera 120. In some instances, the plurality of LEDs 112 are spaced a different radius 142 compared to the camera 120.

It should be appreciated that the one or more lighting and visualization devices 150 can be sized and designed to engage with and fit over top of existing pairs of loupes 10 of various sizes and configurations. In some embodiments, no modification to the existing pairs of loupes 10 is necessary to engage the lighting and visualization device 150. This can allow various users to achieve desired lighting and visualization characteristics using existing pairs of loupes 10. The chassis 102 of the lighting and visualization device 150 may be designed, sized, and fit specifically for specific models of loupes 10. Moreover, in other embodiments, a pair of loupes 10 may be manufactured as an all-in-one device to include the various lighting and visualization features as described herein.

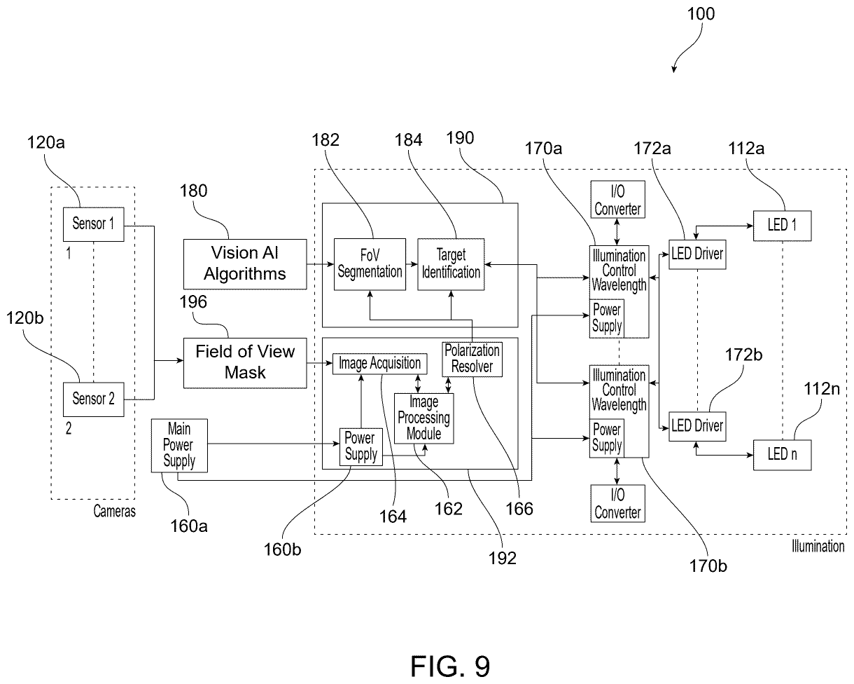

Turning to FIG. 9, a schematic diagram of the system 100 is shown. As illustrated, the system 100 comprises at least two video sensors or cameras 120a and 120b, and a plurality of LEDs 112a-112n. The system 100 further comprises at least one main power supply 160a and secondary power supply 160b. The power supplies 160a and 160b may be any suitable power supply, such as a 120V to 12V converter, a battery, etc. It should be appreciated that any number of power supplies may be provided. Moreover, the power supplies 160 may be located at the device 150 or external to the device 150 where power is provided through a wired connection with the device 150. In other examples, the device 150 may include at least one dedicated power supply 160 (e.g., such as a battery) on the device 150, and there may be a secondary power supply 160 (e.g., second battery or wired connection AC/DC power) external to the device 150. For example, for wireless embodiments of the device 150, the device 150 may include a power supply 160 in the form of a rechargeable battery.

The system 100 includes various processing modules configured to operate, analyze, interpret, and/or enhance image or video data captured by one or more cameras 120 or to operate the various LEDs and other components. The functionality of the various modules described herein may be executed by a controller (or plurality of controllers) integrated within the device 150 itself or by an external controller (or plurality of controllers) communicatively coupled to the device (e.g., via a wired or wireless connection). The controller (or plurality of controllers) may comprise one or more processors, digital signal processors (DSPs), microcontrollers, field-programmable gate arrays (FPGAs), application-specific integrated circuits (ASICs), or other computing elements capable of performing the operations and functionality described herein.

For example, the system 100 can include controllers 190 and/or 192 configured to control or otherwise communicate with the various sensors or components via a wired or wireless communication link. The controllers 190 or 192 may include a processor and a non-transitory computer-readable medium storing instructions that, when executed by the processor, cause the system to perform the various functions described herein, such as activation of the light-emitting diodes, control of image capture by the camera, analysis of image capture and image processing, field of view masking, field of view segmentation, target identification, illumination control, and the like. The controllers 190,192 can be located locally to the various sensors, or remotely. The controllers 190, 192 can receive sensor data, commands, store corresponding information, and/or perform the various processing tasks and controls as described. It should be understood that any number of the controllers 190, 192 may be used, and that various functionality can be handled on shared or separate controllers.

In certain embodiments, the controllers 190,192 can also communicate various information to a server. The server can be local, remote, or cloud-based as part of a cloud computing environment. In various embodiments, additional controllers can exist as part of the server. The server can also be distributed among multiple locations and/or devices. In general, a network can be implemented to couple one or more devices of the system 100 via wired or wireless connectivity, over which data communications are enabled between devices and between the network and at least one of a second network, a subnetwork of the network, or a combination thereof. It is to be appreciated that any suitable number of networks can be used with the subject innovation and data communication on networks can be selected by one of sound engineering judgment and/or one skilled in the art.

The system 100 may include an image processing module 162 capable of receiving and processing image data from the various camera sensors 120 or the image acquisition module 164, according to any of the description provided herein. These operations may include, but are not limited to, filtering, edge detection, object recognition, feature extraction, image segmentation, depth estimation, color correction, and compression. Processed image data may be used for display, storage, transmission, or further computational analysis. The modularity of the processing architecture allows for flexible deployment, either fully embedded within the device 150 or distributed across external computing resources such as a remote server or cloud-based platform. Moreover, it should be appreciated that the imaging from the camera 120 may be stored on suitable hardware or cloud-based storage platforms and processed by the image processing module 162 in real time or any time thereafter.

Additionally, the system 100 may include a dynamic polarization module 166. The polarization module 166 may facilitate illumination and polarization control or otherwise polarization manipulation flexibility. This may be helpful for applications such as glare reduction, which may enhance contrast imaging, and selective illumination of polarization-sensitive materials, polarization-based edge detection, and material classification can be dynamically optimized for each scene.

The polarization module 166 may also be used to generate complex polarization patterns and gradients. By precisely controlling the orientation and ellipticity of polarization at each point, the module may create intricate polarization patterns that enable interaction with materials and surfaces to address better object visualization and glare reduction. The polarization control and enhancement may be accomplished, as described above, by controlling various aspects of the plurality of LEDs to achieve more desirable polarization parameters. The polarization control and enhancement may further be handled through software or by the selection of different hardware. For instance, the system 100 may switch between various cameras 120 to achieve a more desirable video feed. In other words, the system 100 may incorporate advanced feedback mechanisms that can sense and adapt to the polarization properties of illuminated objects, allowing for intelligent, responsive lighting and control of devices that maximizes visibility and information extraction in various environments.

To facilitate control of the plurality of LEDs 112, a plurality of illumination control modules 170 and LED driver modules 172 may be provided. It should be appreciated that that each individual LED 112 may be controlled via a respective LED control module 170 and LED driver module 172. In this manner, each respective LED 112 may be independently controlled. Aspects of control may include any applicable LED control feature such as intensity, frequency, etc. Such control may be based at least partially on data received from the camera sensors 120, the various control modules, or data provided by the AI vision algorithms 180, FoV segmentation module 182, target identification module 184, or the like.

The system 100 may also include a field of view masking module 196. Field of view (FoV) masking, as discussed herein refers to a method of constraining image data acquisition, processing, or display to a predefined angular or spatial region corresponding to the effective optical field of view of a camera 120 of the system 100. The field of view masking module 196 may receive real-time image or video data from one or more cameras 120, and may apply a masking function that excludes portions of the image frame or sensor data that fall outside a defined field of view, based on parameters such as angular range, focal depth, or device orientation. This masking may be implemented through software using geometric transformations, pixel-level region masking, or real-time projection filtering, and may reduce visual clutter, enhance procedural focus, and improve the accuracy of downstream image processing algorithms (such as image analysis). In some embodiments, the FoV mask is dynamically adjustable based on sensor alignment, user input, or other predefined criteria.

In certain embodiments, the system 100 includes an artificial intelligence (AI) module 180 configured to analyze live or recorded video feeds to detect objects, events, patterns, or other conditions of interest. The AI module 180 may utilize machine learning models or algorithms such as convolutional neural networks (CNNs), recurrent neural networks (RNNs), transformers, or other deep learning architectures trained on relevant datasets. The analysis may include object detection, classification, tracking, activity recognition, anomaly detection, facial or gesture recognition, and other context-aware interpretations. The AI processing may be performed locally on a device-integrated processor or controller, or externally via a remote computing resource (e.g., edge server or cloud platform). The AI module 180 may operate in real time or on a delayed basis, depending on system requirements. Training and inference models may be updated dynamically or periodically to improve accuracy or adapt to new conditions, ensuring robust and adaptive video analysis across varying environments and use cases. In some embodiments, the AI module 180 may be integrated with other various features or modules of the system 100 to improve lighting and visualization of the system 100. The various connection lines in the system diagrams illustrate either wired or wireless connections between devices, modules, programs, and functionality of the controllers. In some instances the connections may be software interaction between modules rather than physical connections.

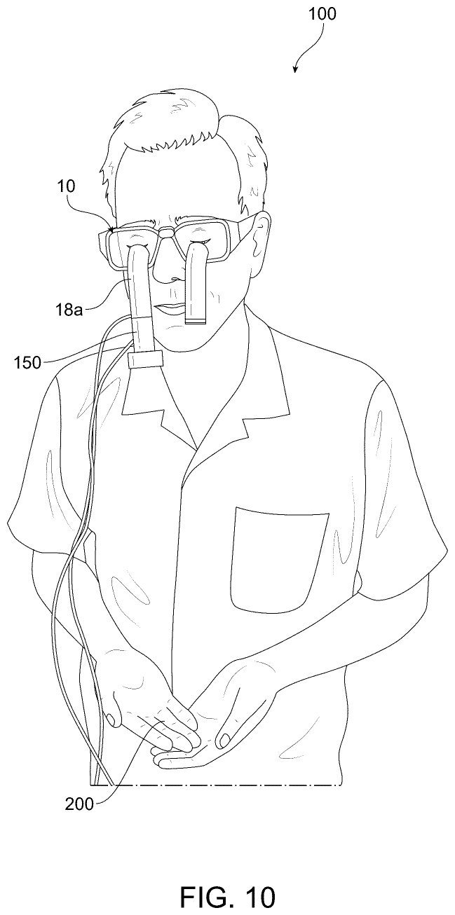

Turning to FIGS. 10-12, various examples of the system 100 or device 150 are provided. In FIG. 10, a lighting and visualization device 150 shown installed onto an ocular 18a of a pair of loupes 10. As illustrated, the field of view and the lighting is directed toward a single point of interest 200.

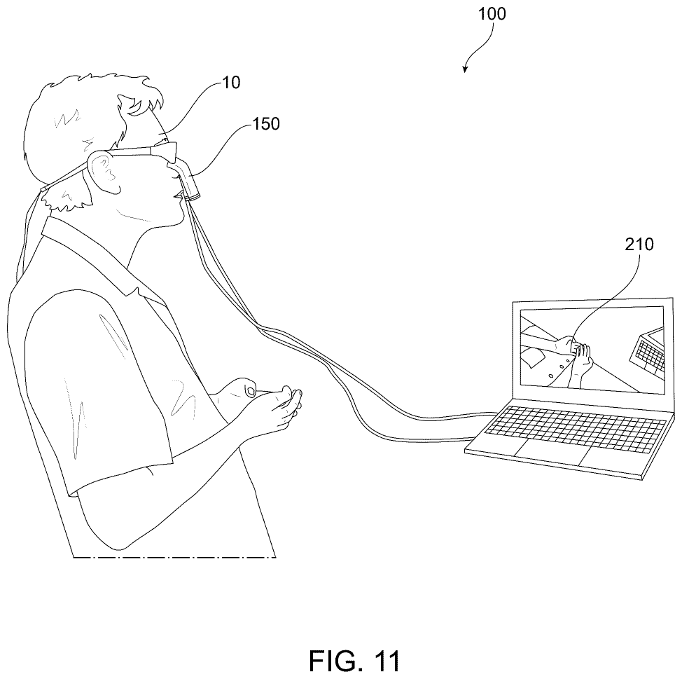

FIG. 11 illustrates the system 100 and the lighting and visualization device 150 in use. As illustrated a real-time video stream of the user's point of view (PoV) is produced on the video screen 210. It should be appreciated that this video stream may be transmitted via hardwire connection, wireless connection, or via a cloud-based network as described above.

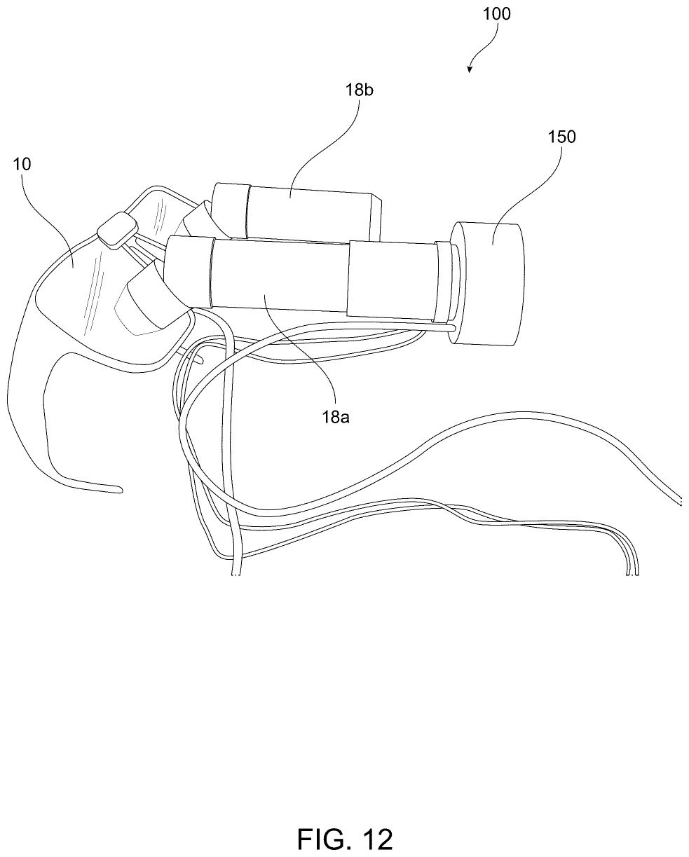

FIG. 12 is an exemplary embodiment of the lighting and visualization device 150 installed onto an existing pair of loupes 10. It should be appreciated that although illustrated with one lighting and visualization device 150 installed onto a single ocular 18a of the loupes 10, a second lighting and visualization device 150 may be installed on the second ocular 18b of the loupes 10.

Further, although certain embodiments have been shown and described, it is understood that equivalents and modifications falling within the scope of the appended claims will occur to others who are skilled in the art upon the reading and understanding of this specification.

What is claimed is:

1. A lighting and image capture apparatus, comprising:
a chassis comprising a first portion, a second portion, and a camera mounting channel extending along a length of the first portion, wherein the first portion of the chassis is configured to removably attach to an ocular of a visual aid device;
an LED board comprising a plurality of light-emitting diodes;
a mounting ring comprising a plurality of concentrically spaced openings and a plurality of lenses installed within a respective opening of the plurality of concentrically spaced openings of the mounting ring to align a respective lens with a respective light-emitting diode of the LED board, wherein the LED board and the mounting ring are mounted within a cavity of the second portion of the chassis such that the plurality of light-emitting diodes are oriented in a direction corresponding to a field of view of the ocular; and
a camera installed within the camera mounting channel, the camera is aligned and configured to capture image data associated with the field of view of the ocular.

2. The lighting and image capture apparatus of claim 1, wherein the visual aid device is a pair of loupes comprising a pair of lenses, each of the pair of lenses comprising a corresponding ocular.

3. The lighting and image capture apparatus of claim 1, wherein the chassis, the LED board, and the mounting ring each comprise a central opening, the central openings being concentrically aligned to define a visual pathway therethrough.

4. The lighting and image capture apparatus of claim 3, wherein the visual aid device is a pair of loupes and the visual pathway is aligned with the field of view of an ocular of the pair of loupes such that a user of the pair of loupes can visualize a target through the central openings.

5. The lighting and image capture apparatus of claim 1, wherein the camera and the plurality of light-emitting diodes are oriented in a direction to capture imagery and direct illumination toward the field of view of the ocular.

6. The lighting and image capture apparatus of claim 1, further comprising a controller configured to:
control operation the plurality of light-emitting diodes; and
control image capture by the camera.

7. The lighting and image capture apparatus of claim 6, wherein the controller is further configured to process, in real time, image data captured by the camera to identify at least one target within a field of view of the camera.

8. The lighting and image capture apparatus of claim 7, wherein the controller is further configured to regulate operation of the light-emitting diodes based upon predefined criteria, image data captured by the camera, or sensed conditions from the camera.

9. The lighting and image capture apparatus of claim 8, wherein the sensed conditions from the camera comprise sensed polarization parameters, and the controller is configured to analyze the sensed polarization parameters to produce an improved image quality.

10. The lighting and image capture apparatus of claim 9, wherein the controller is configured to analyze the sensed polarization parameters to produce an improved image quality by adjusting control parameters of the light-emitting diodes to achieve a more desirable image, the control parameters comprising one or more of illumination intensity, color temperature, or dominant wavelength.

11. The lighting and image capture apparatus of claim 1, wherein an inner diameter of the first portion of the chassis corresponds to an outer diameter of the ocular of the visual aid device such that the first portion is removably attached to the ocular of the visual aid device, the chassis comprises a central opening that is concentrically aligned with a visual pathway of the ocular when the first portion is attached to the ocular.

12. A lighting and image capture system, comprising:
a chassis comprising a first portion, a second portion, and a camera mounting channel extending along a length of the first portion;
an LED board comprising a plurality of light-emitting diodes installed concentrically around the LED board, wherein the chassis and the LED board each comprise a central opening, the central openings being concentrically aligned to define a visual pathway therethrough;
a camera installed on the chassis within the camera mounting channel; and
a controller comprising a processor and a non-transitory computer-readable medium storing instructions that, when executed by the processor, cause the system to:
control operation of the plurality of light-emitting diodes;
operate the camera to capture image data; and
process, in real time, the image data captured by the camera to identify at least one target within a field of view of the camera and to regulate operation of the light-emitting diodes based upon predefined criteria, image data captured by the camera, or sensed conditions from the camera, wherein the camera and the plurality of light-emitting diodes are aligned and configured to capture image data associated with the field of view.

13. The lighting and image capture system of claim 12, wherein the first portion of the chassis is configured to attach to an ocular of a pair of loupes to provide lighting and image capture capabilities to the pair of loupes, the camera and the plurality of light-emitting diodes are aligned and configured to capture image data associated with a field of view of the ocular.

14. The lighting and image capture apparatus of claim 12, wherein the controller is further configured to process, in real time, image data captured by the camera to identify at least one target within a field of view of the camera.

15. The lighting and image capture apparatus of claim 14, wherein the controller is further configured to regulate operation of the light-emitting diodes based upon predefined criteria, image data captured by the camera, or sensed conditions from the camera.

16. The lighting and image capture apparatus of claim 15, wherein the sensed conditions from the camera comprise sensed polarization parameters, and the controller is configured to analyze the sensed polarization parameters to produce an improved image quality.

17. The lighting and image capture apparatus of claim 16, wherein the controller is configured to analyze the sensed polarization parameters to produce an improved image quality by adjusting control parameters of the light-emitting diodes to achieve a more desirable image, the control parameters comprising one or more of illumination intensity, color temperature, or dominant wavelength.

18. A system comprising,
a pair of loupes having at least one ocular;
a lighting and image capture apparatus configured to attach to the at least one ocular to provide lighting and visualization for the pair of loupes, the lighting and image capture apparatus comprising:
a chassis comprising a first portion, a second portion, and a camera mounting channel extending along a length of the first portion;
an LED board comprising a plurality of light-emitting diodes;
a mounting ring comprising a plurality of openings;
a plurality of lenses, each of the plurality of lenses installed within a respective opening of the plurality of openings of the mounting ring to align a respective lens with a respective light-emitting diode of the LED board, wherein the LED board and the mounting ring are installed within a cavity of the second portion of the chassis, and chassis, the LED board, and the mounting ring each comprise a central opening, the central openings being concentrically aligned to define a visual pathway therethrough; and
a camera installed on the chassis within the camera mounting channel, and
wherein the camera is configured to capture image data associated with a field of view of the at least one ocular of the pair of loupes and the plurality of light-emitting diodes are configured to provide illumination to the field of view.

19. The system of claim 18, further comprising a second lighting and image capture apparatus configured to attach to a second ocular of the pair of loupes.

20. The system of claim 19, wherein the first lighting and image capture apparatus and the second lighting and image capture apparatus are configured to operate as a pair to provide a stereo video capture system.
